(19) United States
(12) Patent Application Publication
(10) Pub. No.: US 2017/0223028 A1
(43) Pub. Date: Aug. 3, 2017

(54) APPARATUS, SYSTEMS AND METHODS FOR PROTECTING AGAINST MALICIOUS MESSAGES

(71) Applicant: Kfir LUZZATTO, Omer (IL)

(72) Inventor: Kfir LUZZATTO, Omer (IL)

(21) Appl. No.: 15/501,896

(22) PCT Filed: Sep. 8, 2015
(86) PCT No.: PCT/IL2015/050905

§ 371 Date: Feb. 6, 2017

Related U.S. Application Data
(60) Provisional application No. 62/053,254, filed on Sep. 22, 2014.

(51) Int. Cl. H04L 29/06; G06F 21/55; G06F 21/62; G06Q 10/10; G06F 21/56

(52) U.S. Cl. CPC H04L 63/14; G06Q 10/107; G06F 21/566; H04L 63/145; G06F 21/6245; H04L 63/105; H04L 63/1441; G06F 21/552

(57) ABSTRACT

A Message Filter receives a message intended for a specific Recipient and determines whether an escrow value has been deposited in relation to said message.

### FIELD OF THE INVENTION

The present invention relates to the protection against malicious messages. More particularly, the invention relates to apparatus, systems and methods useful to assist recipients of electronic messages reduce and, in some modes of action, prevent the reception of malicious messages sent to their electronic messaging systems.

### BACKGROUND OF THE INVENTION

Electronic messages are nowadays an essential part of almost everybody's life. In the context of this description “electronic messages” include, but are not limited to, email messages, SMS (also referred to as “text messages”), MMS messages, which may include audio, images or video, instant messages (IM), which are integrated with a variety of systems such as, for example. Facebook's Messenger, Google's Hangouts, WhatsApp, etc. Unfortunately, their very nature, which makes them essential, electronic messaging systems are also the vehicle through which malicious messages are sent to their user.

In the context of this description “malicious messages” should be interpreted simply as referring to any message that the recipient would. prefer not to receive. In the context of this invention the terms “Recipient” and “User” may be used interchangeably. Said messages include innocuous spam messages, which cannot directly harm recipients but indirectly harm them by creating a waste of time and potential aggravation due to their contents, and also spoofing and phishing messages, which are sent with the intent to harm the recipient in a variety of ways, such as the introduction of malware, including viruses and spyware in the recipient's system, or by tricking the recipient into clicking a link that will take them to a malicious website or will cause malware to be downloaded to his device. The results can be disastrous for the recipient, leading to data loss, system failure, identity theft and to a variety of negative results of different severity.

Virtually any system employing electronic messaging is exposed to threats of this kind, be it a PC or other computing device located in a system, a smart phone, a tablet PC, etc. The art has so far addressed this problem on different levels, starting with filters that recognize some of the malicious messages based on user-supplied information or typical behavior (for instance, stopping messages containing variations of the word “Viagra”), and by providing anti-malware software at the recipient's end, to stop the malware from performing its activity, once downloaded from the malicious message or link that comes with it.

However, the art has so far failed to provide an efficient way to stop malicious messages from reaching their intended recipient and, therefore, prior art methods and systems require sophisticated appliances, servers and the like apparatus and software, to deal with the problem when it has already become a more immediate threat.

It is an object of the present invention to provide a simple solution to the above-described problem, which can prevent malicious messages from reaching their intended recipient.

It is another object of the invention to provide apparatus and systems that can be simply and easily implemented for the purpose of the invention.

It is a further object of the invention to provide a novel, specialized mail client and a system embodying it, which can efficiently carry out the invention in a simple manner.

It is yet another object of the invention to provide a system and a method for the classification of email users, which allows identifying “safe” users, i.e., users who do not send spam from their email account.

It is still a further object of the invention to provide a system and a method useful to improve the accuracy of spam filters.

Other characteristics and advantages of the invention will be easily understood through the following illustrative and non-limitative description of certain embodiments of the invention.

### SUMMARY OF THE INVENTION

In one aspect the invention relates to a Message Filter suitable to receive a message intended for a specific Recipient and to determine whether an. escrow value has been deposited in relation to said message. In one embodiment of the invention the Message Filter is provided with logical circuitry and with communication apparatus suitable to connect to a database containing escrow value deposit data.

In another aspect the invention is directed to a system for filtering messages, comprising:
a) one or more databases suitable to store information relating to message Senders and receivers and to escrow value deposited in relation to a specific message;
b) Message Filter apparatus suitable to receive an incoming message intended for a specific Recipient and to determine whether an escrow value has been deposited in relation to said message; and
c) logical circuitry to select an activity to be performed as a result of the determination carried out by the Message Filter.

The escrow value can be anything of value that can be transferred to the escrow and, according to one embodiment of the invention, it is a monetary value.

The message is not limited to any specific type but according to one embodiment of the invention it is an email message. According to another embodiment of the invention the message is selected from an instant message, a text message, an SMS or an MMS.

In a further aspect the invention is directed to a method for filtering messages, comprising:
a) providing one or more databases suitable to store information relating to message Senders and receivers and to escrow value deposited in relation to a specific message;
b) in a Message Filter apparatus suitable to receive an incoming message intended for a specific Recipient, determining whether an escrow value has been deposited in relation to said message;
c) in a logical circuitry selecting an activity to be performed as a result of the determination carried out by the Message Filter; and
d) optionally forward said incoming message and/or additional information to an intended Recipient.

In one embodiment of the invention the activity to be performed as a result of the determination carried out by the Message Filter is selected from stopping the message from being received by the intended Recipient, forwarding the message to the intended Recipient or sending a message to the intended Recipient.

### BRIEF DESCRIPTION OF THE DRAWINGS

In the drawings:

FIG. 1 schematically illustrates the operation of the server side of a system according to one embodiment of the invention;

FIG. 2 schematically illustrates the operation of a Recipient side system, suitable to operate, inter alia, with the system of FIG. 1;

FIG. 3 schematically illustrates an alternative architecture of a system according to another embodiment of the invention;

FIG. 4 schematically illustrate the architecture of a system according to the invention; and

FIG. 5 is a flow chart of the operation of a system according to the architecture of FIG. 4.

### DETAILED DESCRIPTION OF THE INVENTION

The invention employs a novel type of message filter, which does not analyze the message itself but only determines whether the message meets a predetermined condition that will be explained hereinafter.

According to the invention, for a message to be identified as “safe” a “value” must have been placed in escrow with a trusted party, which may be the same as the operator of the message filter, or maybe a third party. Value placed in escrow by Senders of electronic messages will be returned to them or otherwise credited to them, under predefined and agreed-to conditions.

A simple example would be to set the “value” to be a monetary value, say $0.10 per message. In this simplified example both the Sender and the Recipient would already be subscribers of a service that employs a message filter according to the invention. In this example, Sender has given the service authorization to place in escrow the sum of $0.10 for each message that is sent to a Recipient. This can be done automatically, e.g., through PayPal or other financial institution, or a small sum can be deposited with the service to serve as source funds for the escrow. At the end of a predefined period (e.g., a week or month) that has passed without Recipients' complaints, the sums put in escrow are returned or credited back to Sender, provided the messages he sent were legitimate messages. However, should Recipients complain that one or more of the messages were malicious, the sums put in escrow for those messages will not be returned.

In some embodiments of the invention the email messages will be changed in a novel manner, inasmuch as the system of the invention will add to the header of the message data sufficient to ascertain (as will be further discussed below) that an escrow exists for each specific message, hereinafter also referred to as the “Escrow Validation”. While in several embodiments of the invention the location where the Escrow Validation is placed is the header of the email message, and placing it elsewhere in the message may be less desirable, it is possible to place the Escrow Validation anywhere in the email message, for instance, in the body of the message, and it should be understood that when reference is made herein to the “header” when discussing the Escrow Validation, the term is meant to encompass, in addition to the header itself, any other location where the Escrow Validation may be placed, since the invention can be practiced also outside the message header.

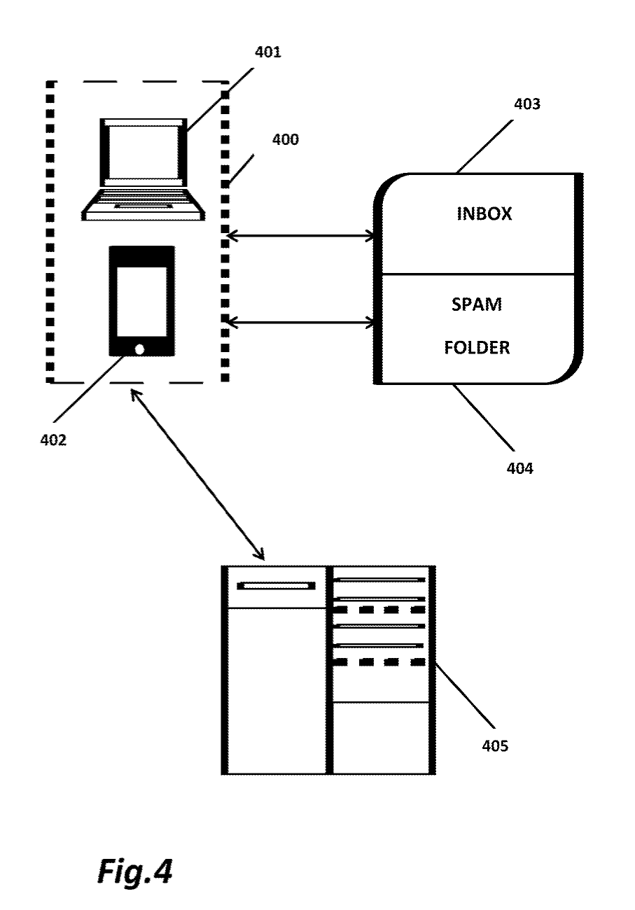

The Escrow Validation can be of any suitable type that can be compared with information contained in the escrow database, and it can be a clear or an encrypted value, as long as in the case of encryption, suitable decryption circuitry is provided either at the database end or anywhere else in the system where the Escrow Validation must be compared with the information contained in the escrow database. In some instances, as will be explained with reference to the embodiment described with reference to FIG. 4, the Escrow Validation can simply be the identity of the sender, for instance, when the sender has provided an escrow for all messages identified with his email address. This particular embodiment obviates the need to modify the header of each message, but the system of the invention otherwise operates in the same manner, since the header of the message must be read to ascertain the identity of the sender's address, which in this case operates as the Escrow Validation.

As will be appreciated by the skilled person the invention immediately renders spamming financially impossible. Take, for instance, a spammer who sends out 10,000 spamming messages a day, in the hope of a 0.01% opening rate. He would have to put in escrow $1000 (according to the example in which $0.1 is taken in escrow for each email message) without any hope of getting them back, since the Recipients or the Recipients' spam filters are likely to identify them and report them as spam. Thus, using the invention, spamming can be not only curtailed, but in some cases it can be prevented altogether. A similar situation would prevail with more dangerous phishing and spoofing attacks, also because of the need for Senders to register with the service and deposit a sum in escrow.

However, the invention would also sensibly reduce the delivery of annoying emails coming from people known to Recipient, who would see their escrow impounded and would think twice before indulging in the indiscriminate dissemination of their emails.

The message filter of the invention cannot be fooled, misled or confused, because it does not attempt to analyze the message and only determines whether escrow funds are available, which can be retained if it is determined by Recipient that the message was malicious.

The service provider operating the message filter and the system in which it is located may, in addition to retaining value for messages discovered to be malicious, retain a small percentage of the escrow value in payment for the service, or may charge a service fee based on the period of time the service is used, or may charge for the service in any other way. The exact financial considerations of the service are not essential to the invention, which is not concerned with the way in which the service provider is remunerated.

The value deposited in escrow will usually be a monetary sum, but can be of any other type, as long as it can be redeemed and must be provided by Sender before the message he is sending has gone through to Recipient.

The invention will now be further illustrated with reference to email system as the representative and illustrative case, although, as explained above and as will be apparent to any person skilled in the art, the following description applies mutatis mutandi also to other electronic messages.

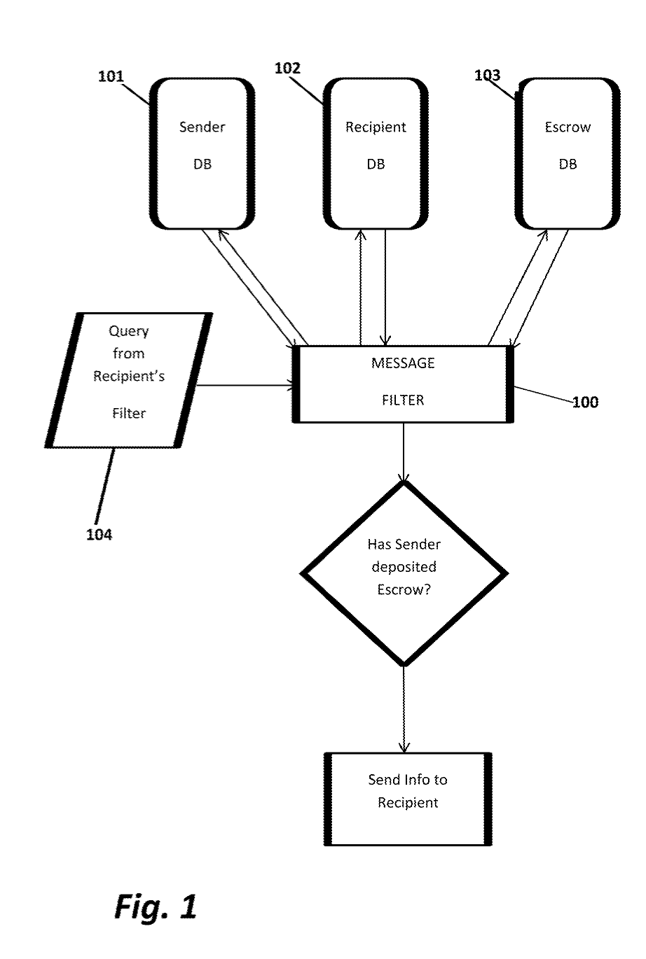

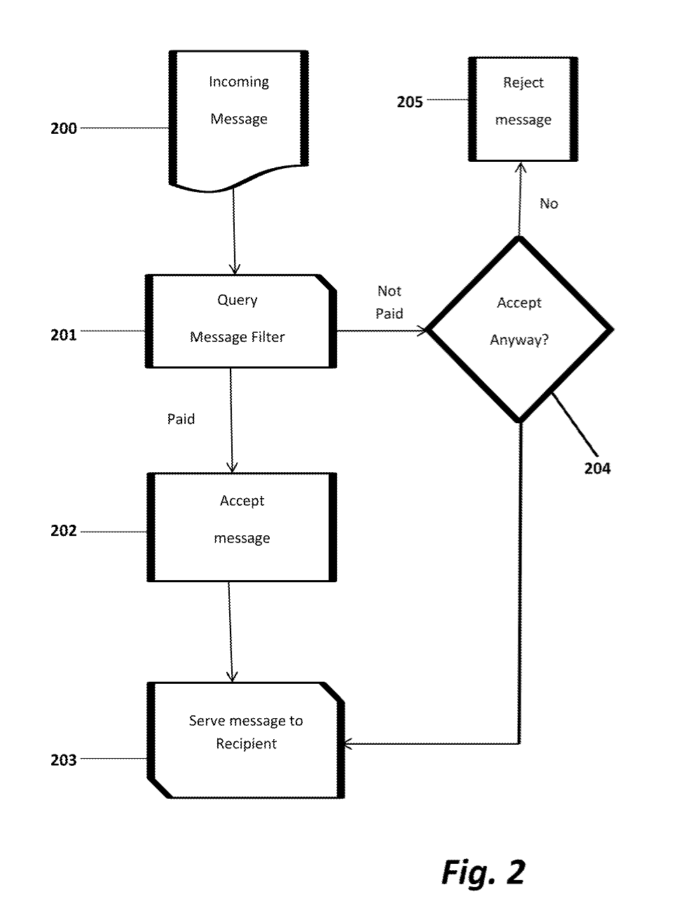

One embodiment of the invention will be described with reference to FIGS. 1 and 2. FIG. 1 schematically shows the operation of a system according to an embodiment of the invention. The central element of the system is Message Filter 100, which can be a server or an appliance with a processor provided with logical circuitry. Message Filter 100 can obtain data from a Sender database, Sender DB 101, which stores information relative to email Senders, such as Senders' identity, registration information, financial information, etc. A Recipient database, Recipient DB 102, stores information relative to email Recipients. Sender DB 101 and Recipient DB 102 can be the same or different databases. Similarly, an escrow database, Escrow DB 103 stores information relating to escrow deposits made by email Senders for specific email messages. Again, Escrow DB 103 can part of be the same database as Sender DB 101 and/or Recipient DB 102, or can be different. The databases can be located at the same location or at different locations. The actual location, structure and nature of the databases is not critical, as long as Message Filter 100 has access to the information they contain.

The Recipient is provided with a Recipient Filter that will be discussed in greater detail in the description to follow, which can be of different types, but the role of which is, in some embodiments of the invention, to participate in the determination of whether the message can be forwarded to the Recipient's inbox. As will become clearer as the description proceeds, the “green light” to the Recipient's system to read the message (i.e., to forward it to the Recipient's inbox and/or make it visible to Recipient) can be the result of a “push” or “pull” process, depending on the set up of the system. Accordingly, in some embodiments of the invention the Recipient Filter will not be needed and will be absent. Furthermore, the Recipient Filter can be fitted at the Recipient's end, or can be provided at a remote location, associated or not with the service provider that operates the Message Filter. Generally speaking, the systems described herein can be distributed, with elements located on different servers, different locations and different systems, or maybe provided as single appliances, since the invention can be carried out using different system architectures.

In the specific example of FIG. 1 a Recipient is provided with a Recipient Filter, and Message Filter 100 receives a Query 104 from it. Query 104 contains information sufficient to identify a specific message received by the Recipient who is querying the system, i.e., the Escrow Validation, which may simply be a message identity number or data sufficient to confirm the existence of the escrow. Message Filter 100 verifies with Escrow DB 103 whether the escrow deposit of the required value has been made, and sends the results of this verification to Recipient. It should be noted that there may be more than one appropriate Escrow Validations, since in certain cases systems may require different escrow deposits, depending on the type of message that Sender is willing to send to a Recipient. For instance, a lower value may be required for sending a simple text message than for a message that has an attachment, or one that contains a hyperlink.

An illustrative example of a header containing an Escrow Validation is shown below:

```
Escrow Validation: 47892135efgt45k1789ZZp476
Return-Path: <example_from@valley.edu>
X-SpamCatcher-Score: 1 [X]
Received: from [134.168.47.111] (HELO valley.edu)
    by fe3.velley.edu (CommuniGate Pro SMTP 4.1.8)
    with ESMTP-TLS id 61288726 for
example_to@mail.valley.edu; Mon, 16 Aug 2014 10:20:9 -
0300
Message-ID: <3221F3CA.1415608@valley.edu>
Date: Mon, 16 Aug 2014 10:20:35 -0300
From: John Doe <example_from@valley.edu>
User-Agent: Mozilla/7.1 (Windows; U; Windows 8.1; en-US;
rv:1.0.1)
X-Accept-Language: en-us, en
MIME-Version: 1.0
To: James Smith <example_to@mail.valley.edu>
Subject: Prduct Marketing Meeting
Content-Type: text/plain; charset=us-ascii; format=flowed
Content-Transfer-Encoding: 7bit
```

Headers must be read from the bottom up and in this example the last line added to the header is the Escrow Validation.

FIG. 2 shows the Recipient's side, according to one embodiment of the invention, when the Recipient can cooperate with the system of FIG. 1. Alternative Recipient configurations are possible, for operating with the system of FIG. 1, which are not shown for the sake of brevity and which would be readily apparent to the skilled person.

In the specific embodiment of FIG. 2 a message is received in Recipient Filter 200, which is provided with communication apparatus 201 that queries Message Filter 100 as to the status of the received message, specifically whether an escrow deposit has been done for it. If the response confirms that the escrow deposit has been made, logical circuit 202 allows it to proceed to the Recipient's inbox 203. If the response is that no escrow deposit has been made the message can be blocked and not served to the Recipient. According to an alternative embodiment of the invention, shown in FIG. 2, a further decision block can be provided, indicated by numeral 204, to determine whether Recipient is willing to accept the insecure message. This can be done, for instance, by displaying in the inbox of the Recipient a notice informing that a message has been received for which no escrow was deposited, providing information such as the origin of the message and its title, to allow the Recipient to make a decision as to whether to accept it in spite of the lack of escrow. If the decision made at this point is to accept the message, it is forwarded to the Recipient's inbox for reading. If the decision is to reject it, the message can be simply blocked, or a rejection notice can be sent to the Sender by Rejection Messenger 205. As will be apparent to the skilled person, decision block. 204 can be actuated manually by the Recipient, or its activity can be automated according to rules preset by its owner.

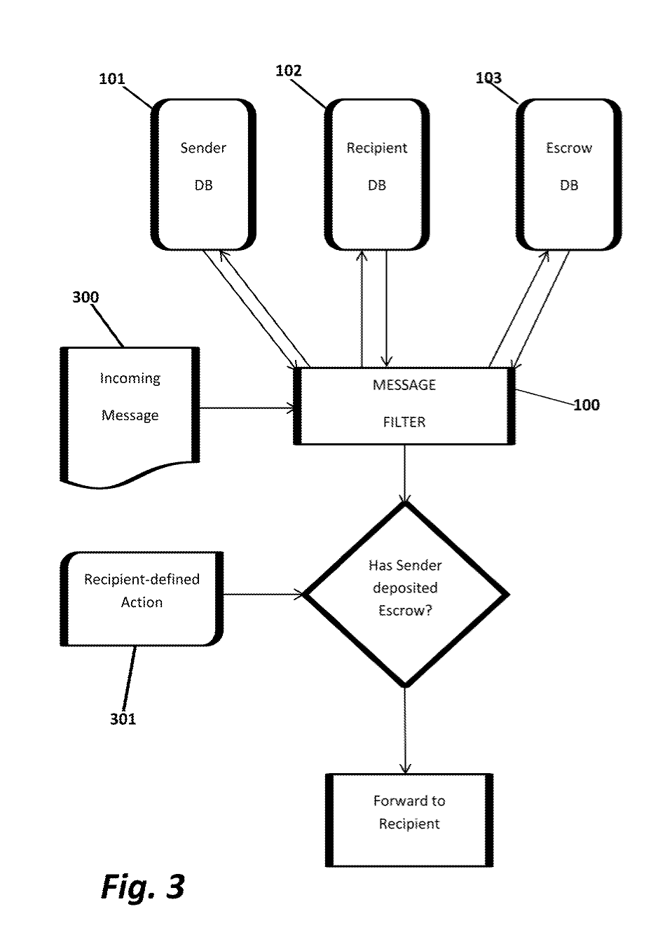

FIG. 3 shows an alternative system according to another embodiment of the invention in which all decisions are taken without the Recipient's intervention, as may happen according to an enterprise's policy, e.g., in an appliance to which all email directed to the enterprise domain passes, or at the email service provider, or in a variety of other setups. According to this specific embodiment of the invention when a message 300 is analyzed by Message Filter 100 and it is determined that the escrow deposit was made, the message is forwarded to the intended Recipient's account, much as it happens with conventional email filters. However, if no escrow value was deposited the message is forwarded to Analysis Processor 301 in which it is further processed according to rules pre-defined by the user, which can be an enterprise setting rules for all of its users, or individual Recipients, who may or may not be part of an enterprise. Analysis Processor 301 may perform more in-depth analyses of the message, using a variety of analytical tools, including external and remote systems and appliances, before deciding whether to suppress the message or to forward it to its intended Recipient.

Although the commercial side of the operation of the system is not an essential part of the invention, for completeness' sake it should be noted that one advantage of the invention is its simplicity vis-a-vis the system's users. All that email Senders have to do is to register with the service and to provide a small escrow sum, or authorization to withdraw it from a financial source. For instance, if a simple message requires an escrow of $0.10, and an average business user may send ten email messages outside his organization every day, given a five days working week and an escrow period of one week, the non-malicious Sender only has to deposits an escrow of five dollars to use the system.

In order to ensure that no undue blocking of innocent email messages occurs, each new Sender identified by the system may, according to one embodiment of the invention, be granted an initial escrow value that is sufficient to deliver a number of email messages (for instance, 200 messages), hereinafter referred to as “grace escrow”. Thus, the Sender will be required to make an actual escrow deposit only if he sends out spam messages, which will exhaust his grace escrow. As long as no complaints are received by Recipients, this Sender will continue to enjoy the freedom to send out email without any disturbance. Thus in another aspect the invention also relates to the reliable classification of mail users as “safe, non-spammers”, which may also be exploited by spam filters to improve their accuracy.

Signing up for the system can be also done on the fly if, for instance, the Recipient is a registered users but the Sender is not. In such a case the Recipient (or an automated system on his behalf) may send a message to the Sender (for instance see block 205 of FIG. 2), that he should register to be able to send him messages. It should be noted that this option is different from existing services that require a Sender to register to be able to send messages to a Recipient, who then must accept the Sender's registration. In such prior art systems there is no penalty for sending a malicious message. Moreover, according to the invention once the escrow value is provided, authorization of the specific message is effected, and not the authorization of the Sender without reference to a specific message. Of course, a Sender may provide escrow value to the system to be applied against specific messages, without the need to deposit the escrow on a message-by-message basis, but the result is the same.

The Recipient, who has received an undesirable (i.e., malicious) message can notify the system of the complaint, and the escrow value deposited in relation to that specific message will not be returned or credited to the Sender. A complaint can be sent in a variety of ways, e.g., by forwarding the message to a complaint address or by using a reporting button provided by the service, and in many embodiments of the invention, simply by moving the message to the spam folder using the method implemented by the email client used by the Recipient. The question of whether the message was “malicious” is in most cases purely subjective and therefore the right to so characterize a message rests with the Recipient.

Recipient Joining with no Change of AIX Records

In some of the embodiments discussed above Recipient registration is required. In such embodiments, email addressed to the Recipient must pass through the system of the invention for certain activities to be carried out. However, this may require the change of the Recipient's MX record so that all email that is addressed to him passed through the system of the invention. The MX record is a resource record in the Domain Name System that specifies a mail server responsible for accepting email messages on behalf of a Recipient's domain, and a preference value used to prioritize mail delivery if multiple mail servers are available. There are some advantages to operating in such fashion; for instance this can be convenient when the Recipient belongs to a large organization that operates its own email server. However, this may be impractical for independent users. The embodiment: described below does not require a change of MX records and is of general applicability. A system configuration useful for carrying out the invention according to this embodiment is schematically shown in FIG. 4, which shows what will be termed hereinafter a “Limited Email Client” or “LEC” 400, which may be a program installed on a PC or an App downloaded from one of the App Stores, for instance to an Android or Apple smart device, which may be any kind of device, e.g., a smartphone, a tablet or other portable devices utilizing a similar operating system. In the figure both a laptop computer 401 and a smartphone 402 are shown and it should be appreciated that either device, or both, or a plurality of devices can be used concurrently or separately to carry out the invention.

The Limited Email Client is a novel type of email client that is configured such that it cannot read the body of the message. Instead, it can only read the header where the Escrow Validation is located. Of course, as described above, placing the Escrow Validation in the body of the message is also possible, and then in a different embodiment of the invention the email client used would not be a LEC, because of the need to retain the ability to read details located in the body, or a different type of LEC can be provided, which is only capable of reading text of a specified format. As will be appreciated by the skilled person, using a LEC assures that the privacy of the Recipient's messages is maintained.

The LEC 400 has access to the Recipient's mailbox, in the same fashion as any other email client, and it can access messages received in the Inbox 403, as well as those moved by the Recipient to the Spam Folder, 404. Moreover, the LEC 400 has access, via any suitable communication channel, e.g., WiFi or cellular network, to an Escrow Database 405.

Let's assume, as an example, that a Recipient (a User) has downloaded a. LEC to the smartphone 402 of FIG. 4. By logging in and granting the LEC access to his email account the User allows the LEC to check the header of messages that he has received. The User can, in some embodiments, provide a list of email addresses that should be ignored by the LEC, as well as other special rules for the handling of messages, such as, for instance, moving messages received from some blacklisted addresses directly to the Spam Folder 404. In this example the LEC checks the User's inbox periodically and when it detects that a new message has been received, it checks the header to determine whether an escrow exists in the system for it. The LEG has two convenient ways to deal with this step:
1. If the message has passed through the system and the header has been modified to include an Escrow Validation (EV), the LEC can confirm that the EV is real and not forged by obtaining the required information from sub-system 405, which contains, or has access to, the Escrow Database.
2. If the Sender has a bulk validation—for instance, a legitimate information provider that disseminates large numbers of legitimate entails—the LEC can verify with sub-system 405 that the Sender's entail address is associated with a valid escrow deposit.

If the email does not possess an EV in its header and the Sender's email is unknown to the sub-system 405, the LEC will return it to the Sender with a note that the message was not delivered to the Recipient and that an escrow has to be created in order for the message to be delivered (this, of course, unless the Sender is on the Recipient's white list or other rules have been set by Recipient.)

The LEG further periodically checks the User's Spam Folder 404. When an email message is received for which an escrow was established, and the Recipient marked it as spam, the LEG will forward this information to sub-system 405, which will take any further required steps, which may include notifying the Sender, debiting the Sender for the escrow amount associated with the spamming message, etc.

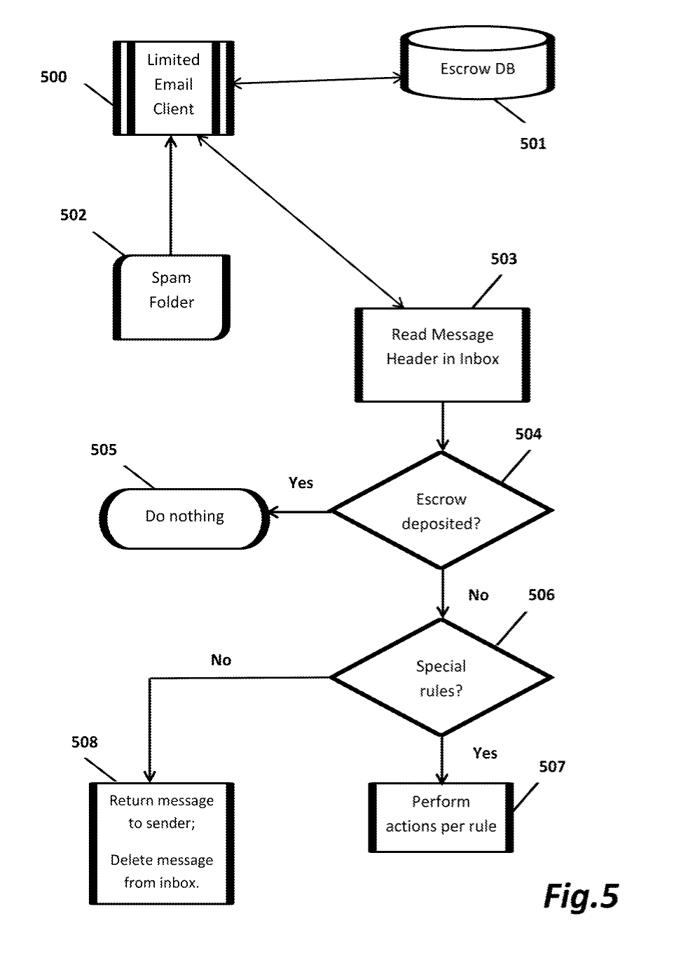

The process is schematically summarized in FIG. 5. A LEC 500 is in communication with an Escrow Database 501 (via any suitable sub-system, not shown) and with a User's Spam Folder 502. The LEC periodically reads the headers of new messages received in Inbox 503 and for each message verifies in Step 504 whether an escrow value was deposited, which is associated with the message or Sender of the message. If such an escrow is found, the LEC ends its handling of the message, in. Step 505. If no escrow deposit is located, the LEC first checks, in Step 506, whether the Recipient has set any special rules for the handling of incoming messages that may be applicable to the message currently being examined. If User's special rules are found, the LEG operates according to them, in Step 507. If no User-defined rules are found, in Step 508 the LEC returns the message to the Sender, with or without an added notice and deletes it from the Recipient's inbox.

It should be understood that for large organization, which operate a dedicated email server, the LEC, sub-system and Escrow Database, as well as the server that operates them, can be provided as an appliance that can operate on the incoming emails either before or after they reach the Recipients' inboxes. The use of an appliance for enterprise emails may have advantages in some case, e.g., because it allows the system administrator to control specific rules and to integrate the knowledge acquired through the operation of the system with the operation of other spam prevention systems.

While the invention has been illustrated with reference to email messages, embodiments of the invention are applicable to any other messaging systems. For instance, when the message is an SMS or an MMS, the Escrow Validation can be obtained using the phone number of the sender. Similarly, for an instant message, the identity of the sender can be derived from his registration in the instant messaging system and, again that can be used as an Escrow Validation that allows the Message Filter to determine whether the sender has deposited a suitable escrow.

The above description of some simple embodiments of the invention was provided for the purpose of illustration and is not intended to limit the invention in any way. Many different server-side end-user side systems can be devised, without exceeding the scope of the invention.

1. A Message Filter suitable to receive a message intended for a specific Recipient and to determine whether an escrow value has been deposited in relation to said message.

2. The Message Filter according to claim 1, which is provided with logical circuitry and with communication apparatus suitable to connect to a database containing escrow value deposit data.

3. A system for filtering messages, comprising:
a) one or more databases suitable to store information relating to message Senders and receivers and to escrow value deposited in relation to a specific message;
b) Message Filter apparatus suitable to receive an incoming message intended for a specific Recipient and to determine whether an escrow value has been deposited in relation to said message; and
c) logical circuitry to select an activity to be performed as a result of the determination carried out by the Message Filter.

4. The Message Filter according to claim 1, wherein the escrow value is a monetary value.

5. The Message Filter according to claim 1, wherein the message is an email message.

6. The Message Filter according to claim 1, wherein the message is selected from the group consisting of: an instant message, a text message, an SMS and an MMS.

7. The system according to claim 3, wherein the escrow value is a monetary value.

8. The system according to claim 3, wherein the message is an email message.

9. The system according to claim 3, wherein the message is selected from the group consisting of: an instant message, a text message, an SMS and an MMS.

10. A method for filtering messages, comprising:
a) providing one or more databases suitable to store information relating to message Senders and Recipients and to escrow value deposited in relation to a specific message;
b) in a Message Filter apparatus suitable to receive an incoming message intended for a specific Recipient, determining whether an escrow value has been deposited in relation to said message;
c) in a logical circuitry selecting an activity to be performed as a result of the determination carried out by the Message Filter; and
d) optionally forwarding said incoming message and/or additional information to an intended Recipient.

11. The method according to claim 10, wherein the activity to be performed as a result of the determination carried out by the Message Filter is selected from the group consisting of: stopping the message from being read by the intended Recipient, forwarding the message to the intended Recipient, sending a message to the intended Recipient, and sending a message to the Sender.

12. A Limited Email Client, which is an email client configured to read information contained in an email header, but which is unable to read the information contained in the body of email messages.

13. The Limited Email Client according to claim 12, which is a device capable of running software and wherein said software is configured to read only the header of email messages.

14. The Limited Email Client according to claim 13, wherein the software is an Application downloadable from an App Store and the device is a portable device.

15. The Limited Email Client according to claim 14. wherein the portable device is selected from a smartphone, a tablet, a phablet and a laptop computer.

16. The limited email message according to claim 13, wherein the device is selected from a PC, a server and an appliance.

17. The Limited Email Client of claim 12, which is a, or part of, a Message Filter suitable to receive a message intended for a specific Recipient and to determine whether an escrow value has been deposited in relation to said message.
